(19) United States
(12) Patent Application Publication
(10) Pub. No.: US 2014/0283014 A1
(43) Pub. Date: Sep. 18, 2014

(54) User identity detection and authentication using usage patterns and facial recognition factors

(71) Applicant: XEROX CORPORATION, Norwalk, CT (US)

(72) Inventors: Francis Kapo Tse, Rochester, NY (US); Zahra Langford, Rochester, NY (US); Jennifer Watts-Englert, Pittsford, NY (US); Mary Catherine McCorkindale, Fairport, NY (US); David Russell Vandervort, Walworth, NY (US); Mary Ann Sprague, Macedon, NY (US); Patricia Swenton-Wall, Victor, NY (US)

(73) Assignee: XEROX CORPORATION, Norwalk, CT (US)

(21) Appl. No.: 13/838,863

(22) Filed: Mar. 15, 2013

(51) Int. Cl. G06F 21/32

(52) U.S. Cl. CPC G06F 21/32
USPC 726/19

(57) ABSTRACT

In a mobile communication device having segregated workspaces respectively associated with a plurality of users, methods and systems are provided for confirming an authorized user in an appropriate account including a corresponding one of the segregated workspaces. Start-up processing of the device includes taking a picture of an authorized image of the authorized user with the device camera. Current activities of the device by the user are monitored relative to a predetermined set of device activities and usage rules. Certain activities are indicative of a change in user of the device from the authorized user. Upon detection of such a change, the current image of the current user of the device is acquired with the device camera. The current image is compared with the authorized image and if the comparison fails to detect a match, the current user is prompted to initiate a log-in process.

### TECHNICAL FIELD

The subject embodiments relate to authentication of a user to use a computer/communication device based upon usage patterns of the device and user facial recognition. More particularly, the embodiments relate to a log-in processing system for a device having a device camera user (image detector) and an activity monitoring engine for monitoring device activities so that when a certain detected activity indicates a possible unauthorized user, the device camera can compare a current image of the user with authenticated user images, and if the comparison determines there is no match, the device may be disabled with respect to some or all of the device content and/or services.

### BACKGROUND

Device log-in processing systems are typically used in computing and communication devices for security reasons so that the individual access to a computing device can be controlled by verifiable identification of an authorized user using some predetermined authenticating credentials provided by the user. Such systems typically involve a prompt from the system itself to a user at the time of turning on the system to enter a password or the like which can be recognized by the system as indicative of an authorized user. Failure to enter a proper password causes the computing device to remain locked against access or use. Login entries, codes or security keys can vary beyond mere alphanumeric passwords to include biometrics such as voice or image recognition. Typically an authenticated user login requires some positive, affirmative action to initiate the authentication process.

Mobile devices, such as smart phones and tablets, are often shared among several users, especially when used in a family setting or owned by a school for general usage. The trend is to have some form of data segregation and a corresponding “log-in” process to confirm user identification to allow access to the correct data. In an environment where some of the users are young, it is hard to train them to use a log-in name and password. Also, a device may just be “lying around” when a young user may happen to have found it and could access other people's data. The level of achievable security is usually a tradeoff between the convenience and complexity of a data protection process. Where the device is used by a family at home or by a group of students and teachers at school, there might be a need to restrict access to certain data or even have separate accounts for each user. There is already some movement towards adding additional protected areas in commercial apps, like Cellrox (http://www.cellrox.com/) or from the device manufacturers and carriers like Blackberry (http://crackberry.com/tags/blackberry-balance) and AT&T (http://www.engadget.com/2011/10/11/atandt-toggle-separates-your-mobile-work-and-play-allows-for-it-m/).

While adding accounts on mobile devices seems like a good approach to protect users from accessing each other's data, in practice, it can be a hindrance and can be difficult to carry out, from the user's perspective. Some examples are:
Typical security policies require a log in to time-out when a device is not in use. Too short a time-out period can cause an annoyance to the user, especially when a long password is required. Too long of a time-out period could leave the device open for “borrowing” while someone else is still logged in.
It is difficult to train young users to log in and log out of account especially when, unlike a PC or laptop, a mobile device is so easily passed around.
Some setups require users to remember to log out of their account whenever they share the device, and then log back in whenever the device is returned.
Separate accounts do not support most people's natural usage behavior. Often devices are desired to be shared fluidly between people. For example, parents often allow their kids to use their phone or tablet while they are driving, waiting in line, or in a restaurant. Logging in and out of separate accounts can be a barrier to sharing the device in these kinds of situations.

Thus, there is a need for a system that can use the built-in capabilities of modern mobile devices to make maintaining separate user data a simpler process. In particular, the system should utilize the best of its capabilities to continuously detect if there has been a change in user instead of continuously timing out and asking for a user to constantly login again.

### SUMMARY

Systems and methods are provided which are comprised of at least two components:
1) An activity engine to monitor any potential changes in device use by the user. If a change is suspected, the second component will be engaged.
2) A user image detector that runs facial recognition on images captured with a back-facing camera to check whether there has been a change in user. If a change is suspected, the user will be prompted to provide identity verification before they can proceed to use the device.

More particularly, a communication device is provided which has a log-in processing system including a user name and password. The device includes a device camera, a start-up processor, an activity monitoring engine and a user image detector. The start-up processor recognizes the user name and the password of an authorized user of the device and acquires an authorized image of the authorized user from the device camera. The activity monitoring engine monitors a predetermined set of device activities indicative of a change in user of the device from a previous authorized user. The user image detector acquires a current image of a current user of the device in response to a detection of the change in user from the activity monitoring engine and for comparing the current image to the authorized image. If the comparison indicates no match between the current user and an authorized user, the current user is prompted to perform a log-in process.

### BRIEF DESCRIPTION OF THE DRAWINGS

FIG. 1 is representation of a computing/communication device including a user interface and a back-facing camera; and

FIG. 2 is a block diagram/flow chart of a system comprising one embodiment of the subject development.

### DETAILED DESCRIPTION

With reference to the Figures, an exemplary embodiment of a computing/communication device 10 is shown including a user interface 12 and a back-facing camera 14. Such devices are well known and used and are often referred to as a smart phone or tablet; although, the features of the subject embodiments are applicable to other types of computing and communication devices that typically require some authentication and/or verification of a user of the device to protect the security of the device, the data accessible therethrough, and only authorized use of the device. The device also includes in its processing systems, processing elements comprising a start-up processor 15, an activity monitoring engine 16, a user image detector and image comparer 17 and a location detector 18. These elements could all be variously combined in a single processor (not shown).

When a user first wants to start using the device 10, the user will go through a standard login process after the device is turned on 20. An initialization process is prompted requiring the user to enter a user name and password 22. Such a standard log-in process serves to introduce and set the data credentials for an authorized user to the device. The log-in process and its complexity, such as length and content of a password, is dictated by the security level that is required. Such processes are well known in the art.

When the user logs in to use a device for the first time, a picture of the user is taken 24 with the rear-facing camera 14. This picture is analyzed in accordance with predetermined analytical algorithms for identifying features of the authorized user. The photograph and the analytical results are stored in a device database. Each time the user logs into the device with the user name and password, a new picture can be captured, which new picture of the user is used to update the user's image information that has been stored so far. Over time, the analytical algorithm in the system will collect more information on what each user should look like to build up better recognition accuracy. The result of the updated images and analytics is that the device will store an authorized user image. It is an object of the subject embodiments that the system will use facial recognition of an authorized user by comparison with the authorized user image information stored as a means to bypass the need for the user to login again. The system will err on requiring the user to login until confidence has been built up recognizing a particular authorized user. One possible approach for such an implementation is to start a time-out period short and force a re-login, with new facial image acquisition, as in current login approaches. The time-out period is adjusted and extended as time goes on where more facial images are acquired of the particular user to build facial recognition confidence, or, as will be discussed later, more usage pattern data has been collected of the user.

There are a lot of different algorithms to store facial information, such as a discussion of How Facial Recognition Systems Work from HowStuffWorks (http://electronics.howstuffworks.com/gadgets/hiqh-tech-gadgets/facial-recognition.htm) or Face Recognition Demo Page posted by MIT Media Lab (http://vismod.media.mit.edu/vismod/demos/facerec/). The intention is to parameterize the user's facial feature and add that into the database as a means to detect that there is no change in user. This approach has the benefit of getting the most up to date image info of the user each time they log in.

The Activity Monitoring Engine (AME) is a piece of software that runs in the background of normal device use that monitors current activities that might indicate a change in user. The AME is responsible for determining when there is a need to acquire an image of the current user to detect if there has been a change in user.

Examples of activities that can signal a user change:
a) that the device was first turned off and then back on;
b) a sudden movement of the device;
c) an opening or a closing of selected device applications;
d) an accessing and/or entering of predetermined inappropriate information;
e) multiple erroneous attempts to execute operations;
f) a deviation from recognized authorized user usage patterns;
g) an access to a predetermined page or folder; and
h) that the device is selectively being operated at a home location or a work location.

Initially, the AME can be set up with fixed rules based on default assumptions. In the most basic operation, the device would behave as if the AME were not there and the device could time out and prompt a user to enter password to log back in. As the engine starts to get feedback from the users' usage patterns, rules will be adaptively refined to minimize the need for user login verification. Each user will acquire their own rules corresponding to their use of the device. Each user thus will have their own account or work space comprising their usage rules associated with their authorized image.

Another option is that users could set preferences to specify activity parameters that cause the device to confirm a change in user. For example, one user might specify that the device should seek user identity whenever apps are accessed from a specific page or folder, which contains a child's games. Another user might specify that the device should confirm identity whenever information is accessed from a work related app. Primary users can also specify whether or not new accounts can be added to the device by others.

The AME can be further assisted with geo-location information that mobile device can have. Different levels of rule checking can be applied, for example, when a device is detected to be in use in the office or when it is being used at home or at a school.

When the AME signals a potential or suggestive change in user, the back-facing camera will take a picture of the user at an appropriate time, e.g., when the user starts interacting with the mobile device by typing or tapping on the screen or after a sudden movement of the device.

The captured current image of the user is processed by the User Image Detector (UID) and compared to the image of the authorized user. If the current image of the user that is using the mobile device is not the same as an authorized user, the user will be prompted to perform the standard login process. As the AME and UID are trained to recognize the usage patterns and facial features of each user, the need for an unnecessary login process will be minimized or totally eliminated.

The cache of user images are based on a continuously learning algorithm such that the last image captured of the identified user is added to the image record to increase robustness of user image identification. This will also reduce misdetection of users due to slow changes in appearance such as if a person is a growing child, a person growing a beard, or a person who has started wearing different glasses or changed hair style.

The UID is also responsible for requesting user identity verification if the current identified user's activity pattern triggers a frequency threshold for the need for image identification even if image identification appears to indicate that a change of user has not occurred. This might signal a system error or a user induced image misdetection condition, such as if a fake user is holding up a picture of another user to try to defeat the facial recognition algorithm.

Another feature of the subject embodiments is that at a time of a normal time-out, which conventionally requires another log-in process, the UID can take a picture of the current user, and if that user is an authorized user, disable the time-out and log-off process.

With reference to FIG. 2, an overall process flowchart is provided which more particularly identifies the aforementioned operating features and elements of the present embodiments.

After the normal log-in process of turning the device on 20, setting a user name and password 22, and initiating storage of an authorized user image 24, is completed, the location detector in the AME may detect 26 a location of the device, which location can be pre-specified as a particular location such as a home, school or business. A particular set of authorized user usage rules 28 for a current user can be set based upon the detected location comprising a predetermined set of device activities normal for the user at that location. The activity monitoring engine will then record and track 30 the usage of the device relative to the referenced usage rules. So long as no activity is detected that would suggest a change in user, the device operates normally and would not have to implement any processes for authenticating and verifying that the user is authorized. However, when the detected activities suggests that there may be a change in user, then the camera takes a picture 34 of the current user and that image of the current user is compared with the stored image of the authorized user 36. If the comparison indicates that the current user image matches the stored authorized image, then the activity which was detected and triggered the taking of the picture may be added 38 as a recorded behavior to the current user usage pattern as an activity not requiring an image capture and comparison process. If the image of the current user does not match an expected authorized image of a user, then the user must be prompted 40 for user identification verification such as by entering a user name and password or other verification (e.g., novel biometric, finger swipe, etc.) could be used. If the user satisfactorily verifies himself as an authorized user, (perhaps there has been a slight change in appearance), then the stored image of the authorized user must be adjusted to recognize the current image as an authorized image and the detected behavior/device activity which triggered the comparison is then added to the authorized usage rules for that particular authorized user. Alternatively, if the current user fails the authorized image comparison but enters a proper identification verification to the prompt, then the system can check 42 to see if new accounts are allowed on the device. If not, the device is locked down 44, then if yes, a new account can be created 46 in which an authorized user image is taken and stored 24. The system includes a process for the owner/administrator of the device 10 to unlock the device using a master unlocking process. The process can be used if the user forgets a password. Also the device owner can add new users or delete users for the device.

Time can be one trigger for the taking of the user image by the camera. As noted above, authorized users' appearances can vary and the system will have to compensate for how a person's face changes over time. Therefore a new picture is added to the database at intervals to make sure validation is as current as possible. This also affects confidence. Transient features like a beard or hair length or color can match at one point in time but not another. So if someone goes blond for a while, then back to brunette, an earlier brunette picture would indicate that it was probably still the same person.

The subject embodiments are beneficial to a device's security when the device includes segregated work spaces containing different contents and services as defined by a particular user's profile. Some of the content and services could be available for common access, like games, phone or browsing. However, specific content or services, e.g., personal address book, portal to company file storage, company e-mail, etc. are segregated content and services that are restricted for a particular authorized user to access. If identity cannot be verified, these restricted content or services could not be accessed anymore.

By having usage rights on a detectable and verifiable profile, measured by usage rules and activity tracking, working accessibility of the device is enhanced across multiple users, while security concerns for individual content and particular uses, are respectively appreciated and protected for the several users of the device.

The subject embodiments comprise a passive system of detecting potential change of user in the use of a shared mobile computing/communicating device. The autodetection minimizes the need for repeated logins by the user due to short time-out periods. The embodiments exploit the use of typical component capabilities in a mobile communication device such as the rear-facing camera and geo-location sensor. Alternatively, a richer user interface, such as gesture interfaces, can be included to obtain a composite estimation if a current user is an authorized user.

The subject embodiments comprise a tradeoff between security and ease of use. Long passwords and short usage time-out periods are required for high security. Such requirements may cause a lot of inconvenience for authorized users. A natural tendency is to shorten the password and lengthen the time-out period so one would not need to constantly re-enter an authentic password. Use of the back-facing camera to provide user identification backed up by the use of identification verification provide a mechanism to tilt the balance to allow for longer (or maybe even no) time-out periods especially in more casual shared mobile device environments, e.g., school or home. Although no security system can actually prevent determined hackers. The subject embodiments make use of the imaging and computation capabilities of the modern mobile device to provide a better tradeoff between security and ease of use, and allow authorized users to casually share their devices with family members or friends without compromising the security of private information on the device.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A communication device having a login processing system including a user name and password including:
a device camera;
a startup processor for recognizing the user name and the password of an authorized user of the device and for acquiring an authorized image of the authorized user from the device camera;
an activity monitoring engine for monitoring a predetermined set of device activities indicative of a change in user of the device from the authorized user; and,
a user image detector for acquiring a current image of a current user of the device in response to a detection of the change in user from the activity monitoring engine and for comparing the current image to the authorized image.

2. The device of claim 1 further including a device disabler for disabling the communication device if the comparing indicates that the current image is different from the authorized image.

3. The device of claim 1 wherein the user image detector acquires features of the authorized user via the device camera upon each use of the communication device by the authorized user when the comparing indicates that the current image is a match to the authorized image.

4. The device of claim 3 wherein the user image detector communicates a prompt to the current user for inputting the user name and password to the communication device when the comparing indicates that the current image is not a match to the authorized image.

5. The communication device of claim 1 further including a location detector.

6. The communication device of claim 5 wherein the location detector recognizes a work location and a home location of the authorized user.

7. The communication device of claim 1 wherein the predetermined set of device activities include:
a) that the device was first turned off and then back on;
b) a sudden movement of the device;
c) an opening or a closing of selected device applications;
d) an accessing and/or entering of predetermined inappropriate information;
e) multiple erroneous attempts to execute operations;
f) a deviation from recognized authorized user usage patterns;
g) an access to a predetermined page or folder; and
h) that the device is selectively being operated at a home location or a work location.

8. The communication device of claim 1 wherein the predetermined set of device activities comprise a change in operating state of the communication device.

9. The communication device of claim 1 wherein the device includes a time-out setting for turning the device off after a time period of device inactivity, and wherein the time-out setting is disabled so long as the user image detector detects the authorized image.

10. In a mobile communication device having segregated work spaces respectively associated with a plurality of users, a method for confirming authentication of an authorized user in an appropriate account including a corresponding one of the segregated work spaces, comprising:
startup processing of the device by taking a picture of an authorized image of the authorized user with a device camera;
monitoring current activities of the device relative to a predetermined set of device activities indicative of a change in user of the device from the authorized user;
taking a current image of a current user of the device with the device camera when the monitoring identifies one of the predetermined set;
comparing the taken current image with the taken picture of the authorized image; and,
requesting a log-in process of the current user when the comparing indicates an unacceptable difference between the current image and the authorized image.

11. The method of claim 10 further including disabling the device when the current user fails the log-in process.

12. The method of claim 10 further including updating the authorized image with updates of the authorized user comprising the current image when the comprising indicates that the current user is the authorized user.

13. The method of claim 11 further including enabling operation of the device with respect to a second appropriate account corresponding to a second authorized user when the comparing indicates that the taken current image is the second authorized user.

14. The method of claim 10 wherein the monitoring includes identifying device activities as one of:
a) that the device was first turned off and then back on;
b) a sudden movement of the device;
c) an opening or a closing of selected device applications;
d) an accessing and/or entering of predetermined inappropriate information;
e) multiple erroneous attempts to execute operations;
f) a deviation from recognized authorized user usage patterns;
g) an access to a predetermined page or folder; and
h) that the device is selectively being operated at a home location or a work location.

15. The method of claim 11 wherein the device includes a time-out setting for turning the device off, and the method includes the taking of the current image at the time-out setting, and keeping the device on when the comparing indicates that the current image is the authorized user.

16. The method of claim 10 wherein the monitoring of the current activities includes comparison with a predetermined set of usage rules.

17. The method of claim 16 including adjusting the usage rules to add a detected activity corresponding to an authorized use by the authorized user, when the detected activity initiates the comparing and the comparing indicates that the current image is the authorized image.

18. The method of claim 10 further including compiling a profile of the authorized user including the authorized image and usage tracking of the device by the authorized user.

19. The method of claim 18 wherein the profile is associated with the appropriate account including the corresponding segregated work space.

20. The method of claim 19 wherein the authorized user is precluded from access to a segregated work space of another authorized user.
